(19) United States
(12) Patent Application Publication
(10) Pub. No.: US 2018/0002640 A1
(43) Pub. Date: Jan. 4, 2018

(54) CONTROL OF SCALE IN WAREWASH APPLICATIONS

(71) Applicant: Rohm and Haas Company, Collegeville, PA (US)

(72) Inventors: Jan E. Shulman, Newtown, PA (US); John Hayes, Collegeville, PA (US); Scott Backer, Phoenixville, PA (US)

(21) Appl. No.: 15/543,639

(22) PCT Filed: Jan. 13, 2016
(86) PCT No.: PCT/US2016/013171

§ 371 Date: Jul. 14, 2017

Related U.S. Application Data
(60) Provisional application No. 62/137,344, filed on Mar. 24, 2015.

(51) Int. Cl. C11D 3/37; C11D 7/14; C11D 7/06; C11D 3/04; C11D 3/10; C11D 3/08; C11D 11/00; C11D 7/12

(52) U.S. Cl. CPC C11D 3/378; C11D 11/0023; C11D 7/14; C11D 7/12; C11D 3/044; C11D 3/3757; C11D 3/10; C11D 3/08; C11D 7/06

(57) ABSTRACT

Provided are compositions useful for cleaning, such as warewashing. The compositions comprise (a) a polymer comprising polymerized units of (i) an ethylenically unsaturated carboxylic acid monomer or salt thereof, (ii) an ethylenically unsaturated sulfonic acid monomer or salt thereof, and optionally (iii) one or more further monomers or salt thereof, the polymer having a Mw from 2000 to 100,000; (b) a water soluble silicate; (c) an alkaline source; and (d) optionally a surfactant.

### FIELD

This invention relates generally to cleaning compositions. More specifically, the invention relates to cleaning compositions that exhibit reduced scaling, for instance in warewash applications.

### BACKGROUND

Warewash formulations typically make use of high levels of caustic or ash to buffer the pH of the washing liquor at the high end of the alkaline region. These systems may also use low concentrations of surfactant (to emulsify food soil and prevent water spotting), phosphonates (as threshold inhibitors to prevent calcium carbonate scale from forming), bleach (to sanitize ware and control spotting on glassware) and polyacrylate dispersants (to keep inorganic scale formation and deposition in check). The formation of insoluble scale under elevated washing temperatures is a concern, and the net result is dishware, such as glasses, plates and tableware, that are heavily encrusted with inorganic scaling.

Conventional polyacrylates are often used to mitigate this film formation, but the exceptionally harsh environment found in warewashing does not provide for a completely satisfactory solution.

Soluble silicates are known to provide corrosion inhibition of various substrates during the dishwashing process. They are also effective chelants of magnesium ions. The negative associated with utilizing silicates in warewash, however, is the formation of magnesium silicate scale, which is usually very difficult to remove/clean once deposited on dishware.

Compositions that are effective at inhibiting scale/spotting in warewash applications are desirable in the industry.

### STATEMENT OF INVENTION

We have now found that compositions as described herein, which contain a sulfonate polymer and a water soluble silicate, exhibit favorable cleaning properties. Advantageously, in some embodiments as described below, it has been found that when the polymer and water soluble silicate are present in the composition at certain weight ratios, the composition overcomes the shortcomings previously experienced with conventional polyacrylate polymers and soluble silicates, such as unsatisfactory cleaning and increased magnesium scaling, particularly when used in the harsh conditions of warewashing.

Accordingly, in one aspect, there is provided a composition useful for cleaning. The composition comprises: a polymer comprising polymerized units of (i) an ethylenically unsaturated carboxylic acid monomer or salt thereof, (ii) an ethylenically unsaturated sulfonic acid monomer or salt thereof, and optionally (iii) one or more further ethylenically unsaturated monomers or salt thereof, the polymer having a Mw from 2000 to 100,000; a water soluble silicate; an alkaline source; and optionally a surfactant.

In another aspect, there is provided a method of cleaning an article in a warewashing machine. The method comprises: applying to the article a composition as described herein.

### DETAILED DESCRIPTION

Unless otherwise indicated, numeric ranges, for instance as in “from 2 to 10,” are inclusive of the numbers defining the range (e.g., 2 and 10). Unless otherwise indicated, ratios, percentages, parts, and the like are by weight. As used herein, unless otherwise indicated, the phrase “molecular weight” or Mw refers to the weight average molecular weight as measured in a conventional manner with gel permeation chromatography (GPC) and polyacrylic acid standards. GPC techniques are discussed in detail in Modem Size Exclusion Chromatography, W. W. Yau, J. J. Kirkland, D. D. Bly; Wiley-Interscience, 1979, and in A Guide to Materials Characterization and Chemical Analysis, J. P. Sibilia; VCH, 1988, p. 81-84. Molecular weights are reported herein in units of Daltons. The term “ethylenically unsaturated” is used to describe a molecule or moiety having one or more carbon-carbon double bonds, which renders it polymerizable. The term “ethylenically unsaturated” includes monoethylenically unsaturated (having one carbon-carbon double bond) and multi-ethylenically unsaturated (having two or more carbon-carbon double bonds). As used herein the term “(meth)acrylic” refers to acrylic or methacrylic. Weight percentages (or wt %) in the composition are percentages of dry weight, i.e., excluding any water that may be present in the composition. Percentages of monomer units in the polymer are percentages of solids weight, i.e., excluding any water present in a polymer emulsion.

As indicated above, in one aspect, the invention provides a composition comprising: a polymer comprising polymerized units of (i) an ethylenically unsaturated carboxylic acid monomer or salt thereof, (ii) an ethylenically unsaturated sulfonic acid monomer or salt thereof, and optionally (iii) one or more further monomers or salt thereof, the polymer having a Mw from 2000 to 100,000; a water soluble silicate; an alkaline source; and optionally a surfactant.

In some embodiment, the ethylenically unsaturated carboxylic acid monomer or salt thereof of the polymer is acrylic acid, methacrylic acid, their salts, or mixtures thereof. A preferred ethylenically unsaturated carboxylic acid monomer is acrylic acid.

In some embodiments, the ethylenically unsaturated carboxylic acid monomer or salt thereof comprises at least 50 weight percent, preferably at least 70 weight percent; and no more than 95 weight percent, preferably no more than 93 weight percent of the polymer. In some embodiments, the amount of the ethylenically unsaturated carboxylic acid monomer or salt thereof is from 50 to 95 weight percent, alternatively from 70 to 93 weight percent, of the polymer.

In some embodiments, the ethylenically unsaturated sulfonic acid monomer or salt thereof of the polymer is 2-acrylamido-2-methylpropane sulfonic acid (AMPS), 2-(meth)acrylamido-2-methylpropane sulfonic acid, 4-styrenesulfonic acid, vinylsulfonic acid, 3-allyloxy, 2-hydroxy 1-propane sulfonic acid (HAPS), 2-sulfoethyl(meth)acrylic acid, 2-sulfopropyl(meth)acrylic acid, 3-sulfopropyl(meth)acrylic acid, and 4-sulfobutyl(meth)acrylic acid, a salt thereof, or mixtures of two or more thereof. A preferred ethylenically unsaturated sulfonic acid monomer or salt thereof is 2-acrylamido-2-methylpropane sulfonic acid sodium salt.

In some embodiments, the ethylenically unsaturated sulfonic acid monomer or salt thereof comprises at least 5 weight percent, preferably at least 7 weight percent; and no more than 50 weight percent, preferably no more than 30 weight percent of the polymer. In some embodiments, the amount of the ethylenically unsaturated sulfonic acid monomer or salt thereof is from 5 to 50 weight percent, alternatively from 7 to 30 weight percent, of the polymer.

Optionally, one or more further ethylenically unsaturated monomers or their salts may be employed in the synthesis of the polymer. Examples of such optional monomers include, without limitation acrylate esters (e.g., C₁-C₆ alkyl acrylate esters) and (substituted) amides (e.g., C₁-C₆ alkyl acryl amides). Preferred optional monomers include ethyl acrylate, butyl acrylate, tert-butyl acrylamide, and maleic anhydride. When used, the optional monomer(s) preferably may comprise between 2 and 22 weight percent of the polymer.

In some embodiments, the polymer has a Mw of at least 8,000, preferably at least 9,000, preferably at least 10,000, preferably at least 11,000, preferably at least 12,000; and preferably no more than 70,000, preferably no more than 50,000, preferably no more than 30,000, preferably no more than 25,000. In some embodiments, the Mw ranges from 2,000 to 50,000.

In some embodiments, the polymer for use in the composition of the invention is derived from polymerized units of 50 to 95 weight percent (preferably 70 to 93 weight percent) acrylic acid and from 5 to 50 weight percent (preferably 7 to 30 weight percent) 2-acrylamido-2-methylpropane sulfonic acid sodium salt. Preferably, the polymer has a Mw from 10,000 to 20,000, more preferably 14,000 to 18,000.

In some embodiments, the polymer is derived from polymerized units of 50 to 95 weight percent (preferably 55 to 82 weight percent) acrylic acid and from 5 to 50 weight percent (preferably 18 to 45 weight percent) 2-acrylamido-2-methylpropane sulfonic acid sodium salt. Preferably, the polymer has a Mw from 10,000 to 20,000, more preferably 11,000 to 18,000.

In some embodiments, the polymer is derived from polymerized units of 60 to 90 weight percent (preferably 66 to 80 weight percent) acrylic acid and from 5 to 20 weight percent (preferably 10 to 17 weight percent) 2-acrylamido-2-methylpropane sulfonic acid sodium salt, and 5 to 20 weight percent (preferably 10 to 17 weight percent) of ethyl acrylate. Preferably, the polymer has a Mw from 25,000 to 45,000, more preferably 30,000 to 40,000.

In some embodiments, the polymer is derived from polymerized units of 50 to 90 weight percent (preferably 55 to 82 weight percent) acrylic acid and from 5 to 40 weight percent (preferably 10 to 35 weight percent) 2-acrylamido-2-methylpropane sulfonic acid sodium salt, and 5 to 20 weight percent (preferably 8 to 17 weight percent) of (-butyl acrylamide. Preferably, the polymer has a Mw from 2,000 to 10,000, more preferably 4,000 to 8,000.

In some embodiments, the polymer is derived from polymerized units of 50 to 95 weight percent (preferably 70 to 93 weight percent) acrylic acid and from 5 to 50 weight percent (preferably 7 to 30 weight percent) 2-hydroxy 1-propane sulfonic acid sodium salt. Preferably, the polymer has a Mw from 15,000 to 25,000, more preferably 19,000 to 22,000.

In some embodiments, the polymer is derived from polymerized units of 50 to 95 weight percent (preferably 85 to 95 weight percent) acrylic acid and from 5 to 50 weight percent (preferably 5 to 15 weight percent) 4-styrenesulfonic acid sodium salt. Preferably, the polymer has a Mw from 2,000 to 10,000, more preferably 5,000 to 8,000.

In some embodiments, the polymer is derived from polymerized units of 50 to 90 weight percent (preferably 60 to 82 weight percent) acrylic acid, from 5 to 25 weight percent (preferably 8 to 20 weight percent) 2-acrylamido-2-methylpropane sulfonic acid sodium salt, and 10 to 30 weight percent (preferably 10 to 22 weight percent) of maleic anhydride. Preferably, the polymer has a Mw from 10,000 to 20,000, more preferably 12,000 to 16,000.

In some embodiments, the composition of the invention contains at least 0.5 weight percent, alternatively at least 3 weight percent, or alternatively at least 5 weight percent of the polymer, based on the total weight of the composition. In some embodiments, the amount of polymer is up to 12 weight percent, alternatively up to 10 weight percent, or alternatively up to 8 weight percent, based on the total weight of the composition.

The polymer may be used in combination with other polymers useful for controlling insoluble deposits in warewashers, including, e.g., polymers comprising combinations of residues of acrylic acid, methacrylic acid, maleic acid or other diacid monomers, esters of acrylic or methacrylic acid including polyethylene glycol esters, styrene monomers, AMPS and other sulfonated monomers, and substituted acrylamides or methacrylamides. The polymer of this invention may be produced by any of the known techniques for polymerization of acrylic monomers or it may be purchased commercially.

Dispersant polymers for use in the invention are commercially available from various sources, and/or they may be prepared using literature techniques. For instance, low-molecular weight dispersant polymers may be prepared by free-radical polymerization. A preferred method for preparing these polymers is by homogeneous polymerization in a solvent. The solvent may be water or an alcoholic solvent such as 2-propanol or 1,2-propanediol. The free-radical polymerization is initiated by the decomposition of precursor compounds such as alkali persulfates or organic peracids and peresters. The activation of these precursors may be by the action of elevated reaction temperature alone (thermal activation) or by the admixture of redox-active agents such as a combination of iron(II) sulfate and ascorbic acid (redox activation). In these cases, a chain-transfer agent is typically used to modulate polymer molecular weight. One class of preferred chain-transfer agents employed in solution polymerizations is the alkali or ammonium bisulfites. Specifically mentioned is sodium meta-bisulfite.

The polymer may be in the form of a water-soluble solution polymer, slurry, dried powder, or granules or other solid forms.

The composition of the invention contains a water soluble silicate. Suitable silicates typically have a water solubility of at least 10 g/100 mL at 25° C., preferably at least 15 g/100 mL at 25° C. Exemplary water soluble silicates for use in the invention include alkali metal silicates, preferably sodium silicate, sodium disilicate, sodium metasilicate, or mixtures thereof. A particularly suitable water soluble silicate is hydrous sodium silicate, available from PQ Corporation as BRITESIL® H20.

In some embodiments, the composition of the invention contains at least 1 weight percent, alternatively at least 3 weight percent, or alternatively at least 5 weight percent of the water soluble silicate, based on the total weight of the composition. In some embodiments, the amount of water soluble silicate is up to 10 weight percent, alternatively up to 8 weight percent, alternatively up to 7 weight percent, or alternatively up to 5 weight percent, based on the total weight of the composition.

The composition of the invention also contains an alkaline source. Suitable alkaline sources include alkali metal carbonates and alkali metal hydroxides, such as sodium or potassium carbonate, bicarbonate, sesquicarbonate, sodium, lithium, or potassium hydroxide, or mixtures of the foregoing. Sodium hydroxide is preferred.

In some embodiments, the composition contains at least 20 weight percent, alternatively at least 40 weight percent, or alternatively at least 60 weight percent of the alkaline source, based on the total weight of the composition. In some embodiments, the amount of alkaline source is up to 80 weight percent, alternatively up to 70 weight percent, or alternatively up to 65 weight percent, based on the total weight of the composition.

In some embodiments, the composition of the invention contains from 0.5 to 12 weight percent of the polymer, from 1 to 10 weight percent of the water soluble silicate, and from 20 to 80 weight percent of the alkaline source, based on the total weight of the composition.

As indicated above, it has been found that, in some embodiments of the invention, inclusion of the polymer and water soluble silicate at certain weight ratios has the effect of overcoming the shortcomings previously experienced with conventional polyacrylate polymers and water soluble silicates, such as unsatisfactory cleaning and increased magnesium scaling, for instance when used in the harsh conditions of warewashing.

Preferably, therefore, the composition contains the polymer and the water soluble silicate at a weight ratio of 6:1 to 1:3, alternatively 4:1 to 1:3, alternatively 3:1 to 1:3, alternatively 2:1 to 1:2, or alternatively 1:1. In some embodiments, the weight ratio of polymer to water soluble silicate is from 2:1 to 1:1, alternatively from 2:1 to 1.2:1.

Optionally, the composition of the invention may contain one or more surfactants. Typical surfactant levels depend on the particular surfactant(s) used; preferably the total amount of surfactants is from 0.5 wt % to 15 wt %, preferably at least 0.7 wt %, preferably at least 0.9 wt %; preferably no more than 10 wt %, preferably no more than 7 wt %, preferably no more than 4 wt %, preferably no more than 2 wt %.

The surfactant may be anionic, cationic, or nonionic. Preferred are nonionic surfactants. Exemplary nonionic surfactants include, without limitation, alkoxylate surfactants, particularly those based on ethylene oxide, propylene oxide, and/or butylene oxide. Examples include compounds having the formula RO-(M)x-(N)n-OH or R—O-(M)x-(N)y-O—R′ in which M and N are units derived from alkylene oxides (of which one is ethylene oxide), x and y are integers from 0 to 20, provided at least one of them is not zero, R represents a C6-C22 linear or branched alkyl group, and R′ represents a group derived from the reaction of an alcohol precursor with a C6-C22 linear or branched alkyl halide, epoxyalkane, or glycidyl ether. In some embodiments, M is derived from ethylene oxide and N is derived from butylene oxide.

The composition may contain other optional components, for instance, oxygen and/or chlorine bleaches, bleach activators, enzymes, foam suppressants, colors, fragrances, builders, antibacterial agents and fillers. Fillers in tablets or powders are inert, water-soluble substances, typically sodium or potassium salts, e.g., sodium or potassium sulfate and/or chloride, and typically are present in amounts ranging from 0 wt % to75 wt %. Fillers in gel formulations may include those mentioned above and also water. Fragrances, dyes, foam suppressants, enzymes and antibacterial agents usually total no more than 5 wt % of the composition.

The composition can be formulated in any typical form, e.g., as a tablet, powder, block, monodose, sachet, paste, liquid or gel. The compositions are useful for cleaning ware, such as eating and cooking utensils, dishes, in an automatic warewashing machine. They may also be used for cleaning other hard surfaces, such as showers, sinks, toilets, bathtubs, countertops, and the like.

The composition can be used under typical operating conditions. For instance, when used in an automatic warewashing machine, typical water temperatures during the washing process preferably are from 60° C. to 75° C. and typical rinse water temperatures during the rinse process preferably are from 75° C. to 88° C. Typical concentrations for the composition are from 500 to 2000 ppm in the wash liquor. With selection of an appropriate product form and addition time, the composition may be present in the prewash, main wash, penultimate rinse, final rinse, or any combination of these cycles.

Some embodiments of the invention will now be described in detail in the following Examples.

### EXAMPLES

### Synthesis of Polymers

Acrylic Acid/AMPS sodium salt copolymer (Polymer B in the examples below) may be prepared by a person of ordinary skill in the art using known methods. A typical procedure is as follows.

To a two liter round bottom flask, equipped with a mechanical stirrer, heating mantle, thermocouple, condenser and inlets for the addition of monomer, initiator and chain regulator is charged 253 grams deionized water. The mixture is set to stir and heated to 72° C. (+/−2° C.). In the meantime, a monomer solution of 209.7 grams glacial acrylic acid and 180.5 grams of 50% solution of sodium AMPS is added to a graduated cylinder, thoroughly mixed for addition to the flask. An initiator solution of 2.1 grams sodium persulfate is dissolved in 20 grams deionized water and added to a syringe for addition to the kettle. A chain regulator solution of 6.7 grams sodium metabisulfite dissolved in 27 grams deionized water is added to a syringe for addition to the kettle. A promoter solution of 0.6 grams of a 0.15% iron sulfate heptahydrate solution is added to a vial and set aside.

Once the kettle contents reach reaction temperature of 72° C., the promoter solution is added. The sodium bisulfite solution cofeed is begun, adding to the kettle over 105 minutes. After 3 minutes, the monomer and initiator cofeeds are started. The monomer feed is added over 110 minutes and initiator cofeed added over 112 minutes at 72° C.

At the completion of the feeds, 17 grams deionized water is added to the monomer feed vessel, as rinse. The reaction is held for 5 minutes at 72° C. In the meantime, the chaser solution 0.5 grams sodium persulfate and 10 grams deionized water are mixed and set aside.

At the completion of the hold, the above solution is added linearly over 5 minutes and held for 15 minutes at 72° C. The chaser solution preps are repeated and added to the kettle over 5 minutes, followed by a 5 minute hold.

At the completion of the final hold, 24.5 grams of deionized water is added to the kettle with cooling. At 50° C. or below a solution of 100 grams of 50% sodium hydroxide is added to an addition funnel and slowly added to the kettle, controlling the exotherm to keep the temperature below 70° C. The funnel is then rinsed with 10 grams deionized water. Finally, 1.5 grams of a scavenger solution of 35% hydrogen peroxide are added to the kettle. The reaction is then cooled and packaged.

### Polymer Molecular Weight.

Molecular weight may be measured by gel permeation chromatograph (GPC) using known methodology, for instance with the following typical parameters:

### Analytical Parameters:

Instrument: Agilent 1100 HPLC system with isocratic pump, vacuum degasser, variable injection size autosampler, and column heater, or equivalent.
Detector: Agilent 1100 HPLC G1362A Refractive Index detector, or equivalent.
Software: Agilent ChemStation, version B.04.03 with Agilent GPC-Addon version B.01.01.
Column Set: TOSOH Bioscience TSKgel G2500PW×1 7.8 mm ID×30 cm, 7 μm column (P/N 08020) with TOSOH Bioscience TSKgel GMPW×1 7.8 mm ID×30 cm, 13 μm (P/N 08025).

### Method Parameters:

Mobile Phase: 20 mM Phosphate buffer in MilliQ HPLC Water, pH˜7.0.
Flow Rate: 1.0 ml/minute
Injection volume: 20 μL
Column temperature: 35° C.
Run time: 30 minutes

### Standards and Samples:

Standards: Polyacrylic acid, Na salts Mp 216 to Mp 1,100,000. Mp 900 to Mp 1,100,000 standards from American Polymer Standards.
Calibration: Polynomial fit using Agilent GPC-Addon software (Polynomial 4 used).
Injection concentration: 1-2 mg solids/mL 20 mM GPC mobile phase diluent. Used for both standards and samples.
Sample concentration: Typically, 10 mg sample into 5 mL 20 mM AQGPC mobile phase solution.
Flow Marker: 30 mM phosphate

### Solutions Preparation:

Mobile Phase: Weigh out 14.52 g sodium phosphate monobasic (NaH₂PO₄) and 14.08 g sodium phosphate dibasic (Na₂HPO₄).
   Dissolve into 11 L MilliQ HPLC water, stir to fully dissolve all solids.
   After they're dissolved and mixed in, adjusted the solution to pH 7 with 0.5 N sodium hydroxide. This solution is used for mobile phase and sample/standard preparation via a fixed volume repipetor.
Flow Marker: Mix, by weight, equal amounts of solid Na₂HPO₄ and NaH₂PO₄. Using the well-blended mix, weigh 1.3 grams and dissolve into 1 liter of the 20 mM AQGPC mobile phase mix.

Other polymers as described in the examples below may be prepared by a person skilled in the art substantially as described above, with appropriate modifications to reagents and conditions. For instance, in polymers containing monomers additional to acrylic acid and AMPS (e.g., Polymer D and Polymer E), the additional monomers (e.g., ethyl acrylate or butyl acrylamide) may be co-fed into the reaction along with the acrylic acid and the AMPS monomers. For polymers where AMPS is replaced with another sulfonic acid monomer (e.g., Polymer F and Polymer G), the appropriate monomer may be simply exchanged for AMPS in the above synthesis. For Polymer H, the maleic anhydride may be added to the kettle prior to the beginning of the feeds.

In the following examples, various compositions are evaluated for their cleaning effectiveness under warewash conditions. Table 1 generally shows the ingredients used to prepare the tested formulations. Typically, a formulation is prepared by physically dry blending the ingredients.

TABLE 1
Formulation Variables - Caustic Based Scenario

| | % | | |
|---|---|---|---|
| Components | I | II | III |
| Caustic Beads | 0-50 | 20-40 | 50-60 |
| Caustic (50%) | 0-25 | 5-15 | 15-25 |
| Soda Ash | 0-60 | 20-40 | 0 |
| Chelant/Builder | 0 | 0 | 0 |
| Water soluble silicate¹ | 0-10 | 1-5 | 0-10 |
| PBTC² (50%) | 0-6 | 4-8 | 4-8 |
| EDTA | 0-5 | 0-4 | 0 |
| Bleaching Agent | 1-3 | 1-3 | 1-3 |
| Polymer | 0-10 | 4-8 | 4-8 |
| Surfactants³ | 1-5 | 2-4 | 2-4 |
| Fillers (Sulfate) | 0-20 | 10-20 | 5-10 |
| Moisture | 0-5 | 0-5 | 0-5 |

¹Britesil H20
²PBTC = 2-phosphonobutane-1,2,4-tricarboxylic acid.
³nonionic alkoxylate surfactant

A Hobart AM-15 high temperature dishwasher is used to assess the impact of inorganic scaling on Libbey-Collin glassware and plastic tumblers often found in a restaurant setting using various inventive and comparative cleaning formulations. The glasses are loaded into a pre-formed rack designed to readily fit into the warewash machine. The cleaning cycle involves a very short (35-45 second) wash cycle at elevated temperatures (66-71° C.), immediately followed by a brief (7-9 second) rinse at temperatures greater than 82° C. This procedure is repeated multiple times in the presence of the tested cleaning formulations. Glasses and plastic tumblers are washed in hard water (300 ppm, 2/1 Ca/Mg) then removed after 3, 7 and 10 cycles, respectively, then evaluated for filming and spotting in a light box utilizing an ASTM standardized test (3556-85, Reapproved 2009)) and a rating system from 1 to 5, as detailed in Table 2.

TABLE 2
Rating System for Cleaning

| Score | Filming | Spotting |
|---|---|---|
| 1 | No Film | No Spots |
| 1.5 | Barely Perceptible | Trace |
| 2 | Slight | Random |
| 3 | Intermediate | ¼ Glass |
| 4 | Moderate | ½ Glass |
| 5 | Heavy | Complete |

Formulations as described in Table 1 are prepared and tested. The inorganic scale build up is analyzed for each article of dishware using the rating system of Table 2, and results are summarized in Table 3 below. In Table 3, the tested formulations all contain 2 weight percent of a nonionic surfactant based on ethylene oxide/butylene oxide. The formulations also contain either a Polymer A or a Polymer B. Polymer A is a homopolymer of acrylic acid with a molecular weight of 4500. Polymer A falls outside the polymer claimed in the invention. Polymer A is a conventional dispersant polymer for warewash applications, available from The Dow Chemical Company as ACUSOL™ 445ND. Polymer B is a copolymer based on 72 wt % acrylic acid and 28 wt % 2-acrylamido-2-methylpropane sulfonic acid sodium salt, and having a molecular weight of 14,000 to 18,000. Polymer B falls within the polymer claimed in the invention. The tested formulations also either do or do not contain a water soluble silicate (Britesil H20). The concentration of Polymer A or Polymer B, when present, in the Table 3 formulations is 6 weight percent. The concentration of water soluble silicate when present is 5 weight percent.

TABLE 3

| | | | | Filming Scores | | | |
|---|---|---|---|---|---|---|---|
| | Polymer | Polymer | | | 3 | 7 | 10 |
| Ex | A | B | Silicate | | cycles | cycles | cycles |
| 1 | Yes¹ | No¹ | No | Glass | 3.7 | 4.2 | 4.8 |
| | | | | St tumbler² | 3.4 | 3.4 | 4.1 |
| | | | | St acrylonitrile³ | 4.7 | 4.7 | 4.8 |
| 2 | No | Yes | No | Glass | 4.1 | 4.6 | 4.8 |
| | | | | St tumbler | 4.2 | 4.3 | 4.7 |
| | | | | St acrylonitrile | 4.2 | 4.8 | 4.9 |
| 3 | Yes | No | Yes | Glass | 4.1 | 4.3 | 4.7 |
| | | | | St tumbler | 3.5 | 3.6 | 3.7 |
| | | | | St acrylonitrile | 3.9 | 5.0 | 5.0 |
| 4 | No | Yes | Yes | Glass | 2.9 | 3.3 | 3.8 |
| | | | | St tumbler | 2.9 | 3.7 | 4.2 |
| | | | | St acrylonitrile | 4.0 | 3.8 | 3.9 |

¹“Yes” indicates the material is present in the formulation, whereas “no” indicates it is not present.
²“St Tumbler” is a styrene tumbler.
³“St acrylonitrile” is a styrene acrylonitrile tumbler.

Example 1 in Table 3 demonstrates that formulations containing a conventional polyacrylate homopolymer (Polymer A) but no water soluble silicate in a caustic rich formulation, result in dishware in which glass scaling is evident after three cycles and continues to get progressively worse after 7 and 10 cycles, respectively. The plastic tumblers also show a high level of scale deposition.

Example 2 demonstrates that replacing the acrylic acid homopolymer of Example 1 with an acrylic/sulfonated copolymer (Polymer B) results in comparable to slightly poorer performance profile on inorganic scaling.

Example 3 shows that use of a water soluble silicate with the conventional Polymer A results in glassware filming scores that continue to be poor overall.

Example 4, on the other hand, shows that the combination of Polymer B with the water soluble silicate, according to the invention, leads to a noticeably improved glass appearance with far less inorganic film deposition. The styrene acrylonitrile plastic tumbler is also far less scaled, even after 10 complete warewash cycles.

TABLE 4

| | | | Filming Scores | | | |
|---|---|---|---|---|---|---|
| | | | | 3 | 7 | 10 |
| Ex | Polymer | Silicate | | cycles | cycles | cycles |
| 5 | A | Yes¹ | Glass | 4.1 | 4.3 | 4.5 |
| | | | St tumbler² | 3.7 | 3.9 | 3.9 |
| | | | St acrylonitrile³ | 3.6 | 4.3 | 4.5 |
| 6 | B | Yes | Glass | 3.1 | 3.3 | 3.3 |
| | | | St tumbler | 3.6 | 3.8 | 4.0 |
| | | | St acrylonitrile | 3.6 | 3.8 | 4.0 |
| 7 | C | Yes | Glass | 3.4 | 3.7 | 3.9 |
| | | | St tumbler | 3.7 | 3.6 | 3.9 |
| | | | St acrylonitrile | 3.9 | 4.4 | 3.8 |
| 8 | D | Yes | Glass | 3.6 | 3.8 | 4.0 |
| | | | St tumbler | 3.5 | 3.7 | 3.7 |
| | | | St acrylonitrile | 3.9 | 3.6 | 4.5 |
| 9 | E | Yes | Glass | 3.6 | 3.8 | 3.8 |
| | | | St tumbler | 3.6 | 3.5 | 3.7 |
| | | | St acrylonitrile | 3.4 | 3.7 | 3.5 |
| 10 | F | Yes | Glass | 3.7 | 3.9 | 4.0 |
| | | | St tumbler | 3.8 | 3.9 | 3.7 |
| | | | St acrylonitrile | 3.5 | 3.7 | 3.6 |
| 11 | G | Yes | Glass | 3.7 | 3.9 | 4.3 |
| | | | St tumbler | 4.0 | 3.6 | 3.9 |
| | | | St acrylonitrile | 3.5 | 3.7 | 3.6 |
| 12 | H | Yes | Glass | 3.9 | 3.7 | 3.7 |
| | | | St tumbler | 3.7 | 3.9 | 3.7 |
| | | | St acrylonitrile | 3.5 | 3.5 | 3.7 |

¹“Yes” indicates the material is present in the formulation.
²“St Tumbler” is a styrene tumbler.
³“St acrylonitrile” is a styrene acrylonitrile tumbler.

Examples 5-12 in Table 4 examine the impact of polymer composition on the effectiveness of the cleaning formulation. Comparative Example 5 (this formulation is the same as Example 3 in Table 3) shows that in the presence of silicate, a conventional homopolymer continues to demonstrate poor overall performance on inorganic scale. In contrast, inventive Examples 6-12 show that the presence of a sulfonated copolymer leads to a noticeably improved glass appearance with far less inorganic film deposition. In each example, the amount of polymer is 6 wt % and the amount of silicate is 5 wt %.

Thus, Example 6 (this formulation is the same as Example 4 in Table 3) shows that a polymer based on 72 wt % acrylic acid and 28 wt % 2-acrylamido-2-methylpropane sulfonic acid sodium salt leads to a noticeably improved glass appearance with far less inorganic film deposition. The formulation in example 5 is the same formulation.

Examples 7-12 contain silicate and an acrylic/sulfonate copolymer follows.

Polymer C is based on 60 wt % acrylic acid and 40 wt % 2-acrylamido-2-methylpropane sulfonic acid sodium salt, having a molecular weight of 11-18 K.

Polymer D is based on 70 wt % acrylic acid, 15 wt % 2-acrylamido-2-methylpropane sulfonic acid sodium salt, and 15% ethyl acrylate, having a molecular weight of 30-40K.

Polymer E is based on 62 wt % acrylic acid, 23 wt % 2-acrylamido-2-methylpropane sulfonic acid sodium salt, and 15 wt % t-butyl acrylamide having a molecular weight of 4-8 K.

Polymer F is based on 72 wt % acrylic acid and 28 wt % 2-hydroxy 1-propane sulfonic acid sodium salt, having a molecular weight of 19-22 K.

Polymer G is based on 90 wt % acrylic acid and 10 wt % 4-styrenesulfonic acid sodium salt having a molecular weight of 5-8 K.

Polymer H is based on 70 wt % acrylic acid, 10 wt % 2-acrylamido-2-methylpropane sulfonic acid sodium salt, and 20 wt % maleic anhydride, having a molecular weight of 12-16K.

Examples 13-14 (Table 5) examine the effect of the ratio between the Polymer B and the water soluble silicate on the effectiveness of the cleaning formulations. In Table 5, the tested formulations all contain 2 weight percent of a nonionic surfactant based on ethylene oxide/butylene oxide. The formulations also contain the indicated amounts of Polymer B and water soluble silicate.

TABLE 5

| | | | | Filming Scores | | | |
|---|---|---|---|---|---|---|---|
| | Polymer | | | | 3 | 7 | 10 |
| Ex | B | Silicate | Ratio | | cycles | cycles | cycles |
| 13 | 6 wt % | 5 wt % | 1.2:1 | Glass | 2.9 | 3.3 | 3.8 |
| | | | | St tumbler | 2.9 | 3.7 | 4.2 |
| | | | | St acrylonitrile | 4.0 | 3.8 | 3.9 |
| 14 | 6 wt % | 1 wt % | 6:1 | Glass | 3.9 | 4.5 | 4.8 |
| | | | | St tumbler | 3.8 | 4.1 | 4.4 |
| | | | | St acrylonitrile | 4.5 | 4.7 | 4.8 |
| 15 | 6 wt % | 10 wt % | 1:1.7 | Glass | 3.5 | 5.0 | 4.9 |
| | | | | St tumbler | 3.5 | 4.0 | 4.4 |
| | | | | St acrylonitrile | 4.3 | 4.8 | 4.7 |
| 16 | 6 wt % | 3 wt % | 2:1 | Glass | 3.7 | 4.2 | 4.8 |
| | | | | St tumbler | 3.8 | 4.0 | 4.4 |
| | | | | St acrylonitrile | 3.6 | 3.8 | 4.3 |

Example 13 in Table 5, containing Polymer B and water soluble silicate at a weight ratio of 1.2:1, demonstrates good cleaning results on both glass and plastic dishware (this formulation is the same as Example 4 in Table 3). Reducing the level of water soluble silicate such that the ratio is 6:1 (Example 14) has a noticeably adverse impact on glass and plastic anti-filming. Increasing the level of water soluble silicate such that the ratio is 1:1.7 (Example 15) also has a noticeably adverse impact on glass and plastic anti-filming. Example 16, with a ratio of polymer to water soluble silicate of 2:1, demonstrated better overall filming results (reduced filming) than Examples 14 and 15. Examples 13 and 16, therefore, suggest that a favorable weight ratio of polymer to water soluble silicate is from 2:1 to 1:1, or 2:1 to 1.2:1.

1. A cleaning composition comprising:
0.5 to 12 wt % of a polymer comprising polymerized units of
(i) 50 to 95 wt % of an ethylenically unsaturated carboxylic acid monomer or salt thereof,
(ii) 5 to 50 wt % of an ethylenically unsaturated sulfonic acid monomer or salt thereof, and
(iii) 0 to 22 wt % of one or more further monomers or salt thereof, the polymer having a Mw from 10,000 to 20,000;
1 to 10 wt % of a water soluble silicate having a water solubility of ≧10 g/100 mL at 25° C.;
20 to 80 wt % of an alkaline source; and
0.5 to 15 wt % of a surfactant;
wherein the weight ratio of the polymer to the water soluble silicate is from 2:1 to 1.2:1.

2. The cleaning composition of claim 1 wherein the ethylenically unsaturated carboxylic acid monomer comprises (meth)acrylic acid or a salt thereof.

3. The cleaning composition of claim 1, wherein the ethylenically unsaturated sulfonic acid monomer comprises 2-acrylamido-2-methylpropane sulfonic acid (AMPS), 2-(meth)acrylamido-2-methylpropane sulfonic acid, 4-styrenesulfonic acid, vinylsulfonic acid, 3-allyloxy, 2-hydroxy 1-propane sulfonic acid (HAPS), 2-sulfoethyl(meth)acrylic acid, 2-sulfopropyl(meth)acrylic acid, 3-sulfopropyl(meth)acrylic acid, and 4-sulfobutyl(meth)acrylic acid, or a salt thereof.

4. The cleaning composition of claim 1, wherein the polymer is derived from polymerized units of 70 to 93 weight percent acrylic acid; from 7 to 30 weight percent of an ethylenically unsaturated sulfonic acid monomer; and from 2 to 22 weight percent of a further monomer selected from ethyl acrylate, butyl acrylamide, and maleic anhydride.

5. The cleaning composition of claim 1, wherein the water soluble silicate is a hydrous sodium silicate.

6. The cleaning composition of claim 1, wherein the water soluble silicate comprises sodium (di)silicate, sodium metasilicate, or mixtures thereof.

7. (canceled)

8. (canceled)

9. The cleaning composition of claim 1, wherein the cleaning composition is a warewash formulation or a hard surface cleaner formulation.

10. A method of cleaning an article in a warewash machine, the method comprising: applying to the article the cleaning composition of claim 1.

11. The cleaning composition of claim 1, wherein the alkaline source is sodium hydroxide.
